(19) United States
(12) Patent Application Publication
(10) Pub. No.: US 2006/0224396 A1
(43) Pub. Date: Oct. 5, 2006

(54) Data-processing system

(76) Inventor: Stéphane Le Cam, Verneuil (FR)

Correspondence Address: YOUNG & THOMPSON, 745 SOUTH 23RD STREET, 2ND FLOOR, ARLINGTON, VA, 22202, US

(21) Appl. No.: 10/564,000

(22) PCT Filed: Jul. 9, 2004
(86) PCT No.: PCT/FR04/01819

§ 371 Date: Mar. 14, 2006

(30) Foreign Application Priority Data
Jul. 11, 2003 (FR) 03/08546

(51) Int. Cl. G06Q 99/00

(52) U.S. Cl. 705/1

(57) ABSTRACT

A system for processing metadata and associated raw data, is designed to aggregate the data in order to establish a plurality of types of reports. The system is automated with the combined use of the following two units: a first unit (1) known as the initialization unit which assembles all of the devices that provide the different functions for the automatic aggregation of the metadata and the associated raw data which are necessary in order to establish a selected type of report (20); and a second unit (2) known as the execution unit which develops the control commands, essentially arithmetic instructions, and which executes same (38).

The invention relates generally to an improved data processing system for conceiving, producing and circulating reports of all kinds, in particular of the Management Information System type, and relates in particular to improved systems for processing data aggregation problems.

Within a business, many persons conceive and establish reports that focus on finance, customers, sales, in fact any domain in which it is necessary to evaluate results and track their evolution (Statistics, Management Information Systems, for example).

For a better understanding of the problem, it is necessary to provide some information on conventional data modeling and data aggregation.

### Conventional Modeling

Raw data is taken from a “flat table” or “flat dish”, for example, a .csv or .txt file made up of records each occupying one row.

All the records have the same format, i.e. the same number of columns, each field (or column) containing the same type of data from one record to another.

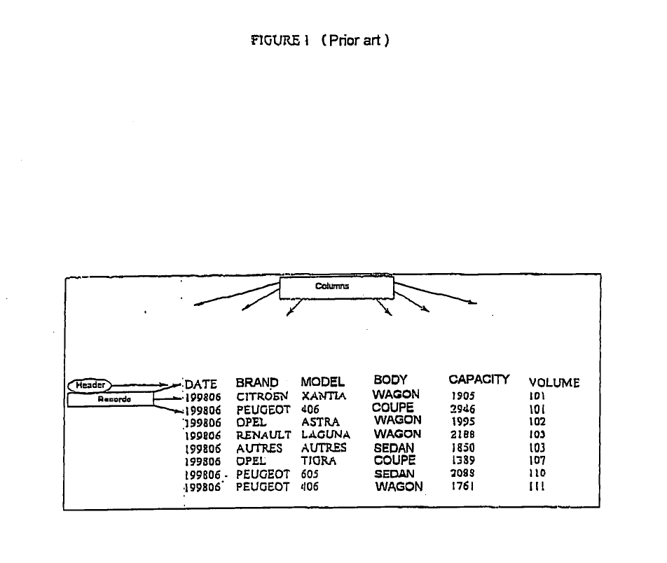

The first row (header) is special because it contains the name of each column. Consider, for example, a file represented in Table 1 in FIG. 1 (Prior art), in which sales of cars in France are entered as and when they take place The columns contain information: DATE, BRAND, etc. The table is extracted from a file comprising several tens of columns and several tens of thousands of rows.

Data Axes

The contents of the various columns have different roles or cannot be used in the same way. For example, it is possible to sum and/or compare the evolution of sales from one month to another.

The data is then structured by means of axes, each axis corresponding to one column of the raw data file. The expression “data item” refers to data of one axis and one record.

There are three types of axis:

Numerical value axes, items in which may be summed, for example, averaged, etc. In this case the axis is called an aggregation axis. Example: the above VOLUME axis.

“Marker” axes, which cannot be aggregated but the items in which can be used to segment the data. Example: the above BRAND axis. Thus the data may be segmented Brand by Brand.

“Time” axes, which contain dates and/or times from which different types of specific computation are possible. The “Time” axes are special cases of the “Market” axes.

In any utilization project, the Time, Market and Value axes must be distinguished on initializing the system.

### Hierarchical Representation of Data

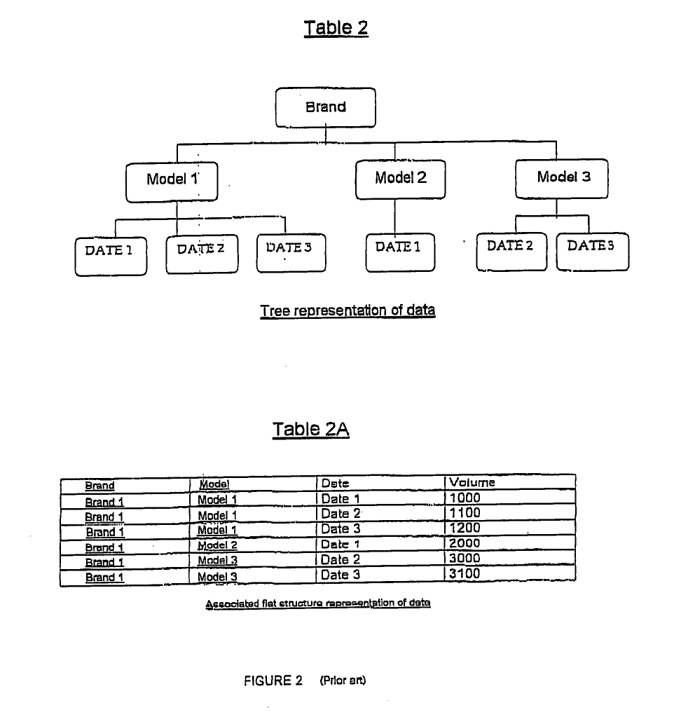

Using the above axes, a hierarchical representation of the data may be designed, and may be modified as a function of the required analysis and the required type of report. Thus the data is placed in random-access memory in accordance with a hierarchical structure organized by the various axes so that a diagram of the data can take the form of a tree, as shown in Table 2 in FIG. 2 in the case of data on three axes.

In Table 2, the “Brand” axis—first level—contains only one item (Brand 1). The “Model” axis contains three items (Model 1, Model 2, Model 3), and the final level, the “Date” axis, also contains three items (Date 1, Date 2, Date 3).

Table 2A in FIG. 2 shows a view of the data such as may be found in a flat file. Six records are shown. Note that, although they exist, the Volumes do not appear in Table 2.

To understand and interpret the diagram, and by convention, it is read from the bottom up: Model 1 is a model of Brand 1. Date 1 is an existing date for Model 1 of Brand 1. The diagram is also read from left to right, so that Date 2 is an existing date for Model 1 of Brand 1, and so on.

Aggregation of Data and Indicators

To impart meaning to the raw data and to refer to the raw data in the reports (Management Information Systems), the aggregation operation is necessary for the data to assume an operational significance and contribute to establishing an overview of the evolution of the domains relating to the data.

Aggregation is defined as a total or partial grouping of the items on a given axis and their respective measurements (indicators) to obtain a unique value by application of a digital computation function such as sums (cumulable), averages, minima, maxima, etc. Each of these functions defines an aggregation mode or aggregation function.

The term “indicator” refers to the numerical item (present in each record row) that is the vehicle of the aggregation, the applied aggregation mode, i.e. the type of computation to which the indicator is subjected, which depends on the axis to which the aggregation relates.

Aggregation produces new numbers that are also indicators whose meaning depends on the axes concerned.

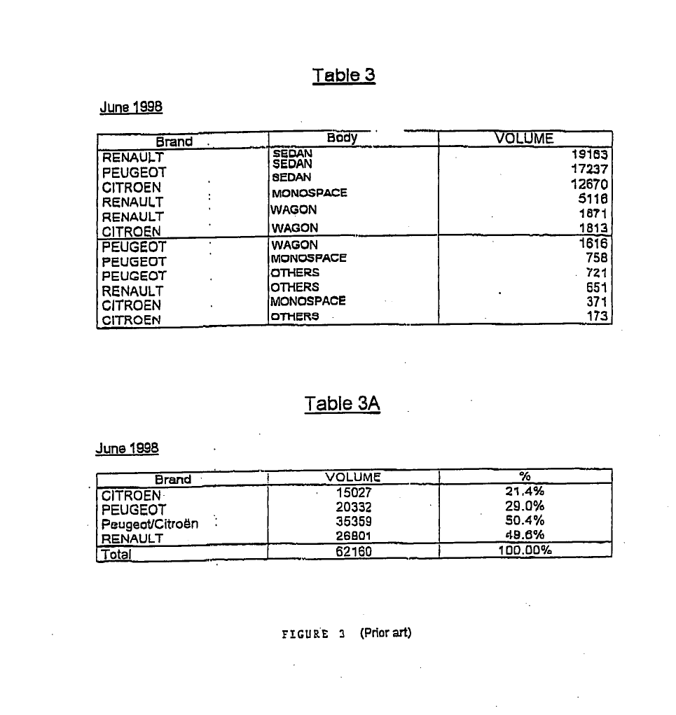

Consider, for example, Tables 3 and 3A in FIG. 3.

In Table 3, the Volume indicator gives the number of vehicles registered as of June 1998 for a given Body of a given Brand.

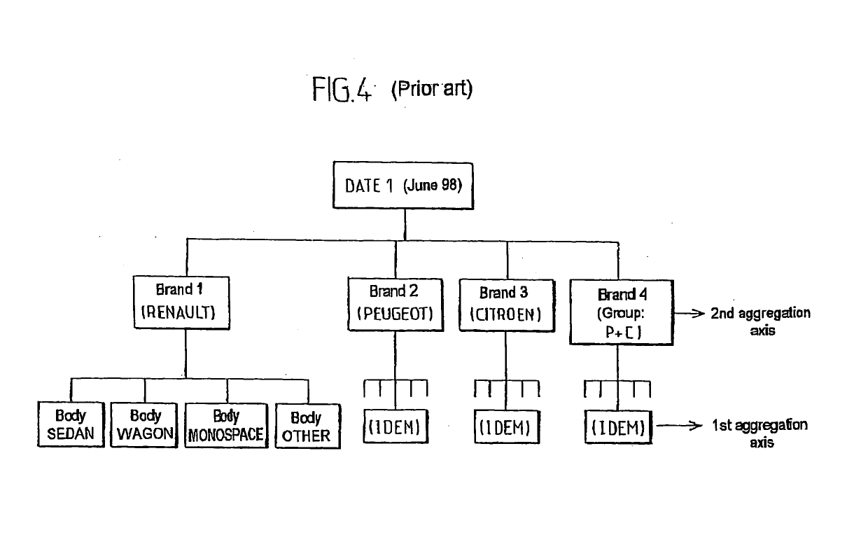

To perform an analysis, the operator introduces the FIG. 4 hierarchical structure into the memory of an initialization module.

If the required analysis is to determine the total vehicles registered in June 1998 for each Brand, it is necessary to aggregate (here accumulate) everything that relates to the Body axis, and there is obtained a total of vehicles of a given Brand, at a given Date, regardless of the Body. The Body axis is referred to as the “Aggregation axis” and the other axes are referred to as “Computation axes”. The result is given in Table 3A of FIG. 3, together with the total as of the given Date, for the Brand axis, the latter then becoming the Aggregation axis.

An operation of grouping Brands (Peugeot+Citroën) has also been effected and a new indicator (namely the percentage %) has been created by computation using a formula producing a new numerical axis (%).

In the above examples, the aggregations are effected exclusively in the form of accumulations However, other aggregation modes must be used with Indicators as varied in kind as interest rates, business days, numbers.

### Aggregation Modes

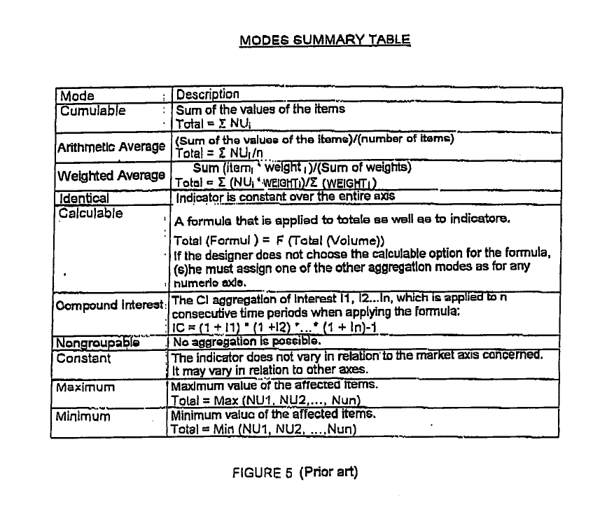

The aggregation modes available are summarized in the FIG. 5 summary table in which NU1, NU2 . . . , Nun represent the values of the items on a numerical axis and WEIGHT, WEIGHT2 . . . WEIGHTn represent the values of the items on another numerical axis.

All the data concerning the axes, the indicators, and the aggregation functions structuring the raw data and conferring values on them is generally designated by a set of “metadata”.

Commercial solutions for producing reports or management information systems from metadata and raw data fall into the decisional and data processing sector, in which a description of the data enables the end user to obtain analysis results consisting at one and the same time of data fields and indicators expressed as a function of those data fields. These descriptions may be established at two levels:

at the level of the source of the data, which means that the addressee of the data can no longer have input to the definition of the computations obtained,

at the level of the addressee of the data, although with any limitations as to the complexity or automation of the computations that may be expressed.

Aggregation computations are based on two principles:

either programming (manual definition), where the exact formula of the computation is defined for each computation node,

or automatically, although with the constraint that the aggregation mode is unique regardless of the computation node or the analysis axis concerned. Because of this, it is necessary to program formulas specific to each node if the computation mode is different. There is therefore at the present time no processing system reconciling at one and the same time automatic computation means and disparity in the modes of expression of the aggregation of an indicator, regardless of the analysis axis.

An object of the invention is to improve a system for simultaneously processing metadata and associated raw data with a view to drawing up different types of report by feeding a system automation whereof has been rendered possible, in particular, by adapting a data processing technical means architecture to the simultaneous use of conventional indicators and new “hybrid” indicators that are defined hereinafter at the beginning of the description of one embodiment of the invention.

According to one general definition of the invention, the method includes the following steps:

i) storing metadata relating to each report type of said plurality of report types and utilization parameters of said metadata in corresponding relationship to each report type,

ii) coding each metadata item and each associated utilization parameter as a function of the corresponding report type,

iii) in response to a request defining the required aggregation level and the indicators and/or axes of data for which a result is expected, selecting at least one report type from said plurality of report types and automatically deducing all the aggregation functions necessary for obtaining said results and the order of application of said aggregation functions,

iv) extracting raw data as a function of corresponding coded metadata for the selected report type,

v) coding the extracted raw data,

vi) associating the coded extracted raw data and the corresponding coded metadata for the selected report type,

vii) calculating the aggregation of the coded raw data associated with the coded metadata in accordance with the utilization parameters coded in this way, all the aggregation functions deduced automatically in this way and the order of application of said aggregation functions, and

viii) automatically drawing up the selected type of report from the aggregation result calculated in this way.

Accordingly, the method of the invention deduces the aggregation functions automatically and dynamically, irrespective of the analysis axis, taking account of the hybrid nature of the indicators and the precedence of the operators applied thereto.

In practice, the metadata item forming an indicator belongs to the group formed by any digital data item of measurement, volume, rate of interest, business days, numbers, percentage type.

In one embodiment, the metadata item forming the aggregation function is a numerical calculation, which may be of the summing, cumulable, averaging, minima, maxima, compound interest, non-groupable, identical, constant type.

In another embodiment, the metadata forming the aggregation function is interlinked in accordance with a selected relationship.

In practice, the relationship between the metadata forming the aggregation function is one of precedence selected as a function of the mathematical property of said aggregation functions.

In a further embodiment, the metadata item forming the analysis axis belongs to the group formed by the date axis, the “market” text axis, the numerical value axis.

In practice, the method further comprises a step of parameter setting to enable the user to modify the unitary behavior of each pair formed by one indicator and one data axis, which allows a plurality of aggregation functions to be associated with the same indicator in relation to each data axis.

Thus the parameter setting step allows definition of indicators, data axes and/or aggregation functions that are personalized and all take account of the precedence of the operators.

A result linking an indicator to one or more data axes is advantageously liable to be considered recursively as an input raw data item for other processes as indicator and/or data axis, which enables very advanced computations to be performed.

In another embodiment of the invention the method comprises the following steps:

a) initializing said first memory means and said second memory means of said initialization module and introducing thereinto the respective characteristics of the preprogrammed types of report and the respective parameters associated with the metadata,

b) said coding means establishing correspondence links between the report types and said metadata,

c) selecting one of the types of report to be drawn up at the level of said selection means,

d) as a function of the selected report type and using first extraction means, extracting local or external raw data accessible by said access means,

e) coding said extracted raw data as a function of metadata relating to at least one selected report type with the aid of second coding means,

f) storing said raw data coded in this way in said second storage means,

g) extracting files from said second memory means via said second extraction means, the metadata and the utilization parameters thereof relating to at least one selected report type and being identified by their respective codes assigned by said first coding means,

h) transferring said metadata extracted by said second extraction means into said respective tables of said buffer means,

i) also transferring into said tables of said buffer moans said coded raw data stored in acid second storage means to complete said respective tables,

j) establishing a sequence of command micro-instructions under the control of said microcontroller of said sequencing means,

k) storing all said micro-instructions in at least one FIFO queue in preparation for a final sequence of command instructions addressed to said microprocessor,

l) executing said sequence of command instructions with the aid of the microprocessor means, the results of which are either transmitted to the functional units adapted to fabricate at least one selected type of report or returned to the database means for raw data in order to constitute a new database reusable to draw up another type of report.

The present invention also proposes a device for processing simultaneously raw data and metadata relating to at least one analysis axis, a simple and/or hybrid is indicator, and/or an aggregation function able to structure and to confer a value on said raw data, with a view to establishing automatically a type of report selected from a plurality of types of report.

According to another important feature of the invention, the device comprises:

means for storing metadata relating to each report type of said plurality of report types and utilization parameters of said metadata in corresponding relationship to each report type,

means for coding each metadata item and each associated utilization parameter as a function of the corresponding report type,

means for receiving a request defining the required aggregation level and the indicators and/or axes of data for which a result is expected,

means for selecting in response to said request at least one report type from said plurality of report types and automatically deducing all the aggregation functions necessary for obtaining said results and the order of application of said aggregation functions,

means for extracting raw data as a function of corresponding coded metadata for the selected report type,

means for coding the extracted raw data,

means for associating the coded extracted raw data and the corresponding coded metadata for the selected report type,

means for calculating the aggregation of the coded raw data associated with the coded metadata in accordance with the utilization parameters coded in this way, all the aggregation functions deduced automatically in this way and the order of application of said aggregation functions, and

means for automatically drawing up the selected type of report from the aggregation result calculated in this way.

According to another aspect of the invention, the system for processing metadata and raw data is characterized in that it is rendered automatic by the device combining two modules which can process any simple or hybrid indicator model, the system comprising:

an initialization module including:

microcomputer means,

automatically accessible first memory means for storing characteristics of a preprogrammed plurality of report types,

second memory means organized into files for storing metadata relating to each report type of said plurality of report types and with which utilization parameters are associated,

first coding means connected between the first memory means and the second memory means to code each item of metadata and each of its associated utilization parameters as a function of the preprogrammed report type to which they relate,

selection means connected to said first memory means to select at least one given report type from said preprogrammed plurality of report types,

local or external raw data database means that can be associated with said metadata and are provided with access means,

first extraction means for extracting said associated raw data connected to said access means and to said selection means to extract the raw data associated with said metadata relating to at least one selected report type,

second coding means for coding said raw data extracted by said first extraction means to assure a correct association between it and the metadata relating to said report type selected by said selection means,

storage means connected to said second coding means for storing said extracted raw data,

an execution module including:

second extraction means connected to said second memory means, said selection means and said storage means of said initialization module,

buffer means coupled to said second extraction means to store, firstly, the metadata relating to at least one given report type selected by said selection means in the respective tables and, secondly, for completing said respective tables with said associated raw data extracted from said storage means by said second extraction means,

sequencing means coupled to the buffer means and comprising microcontroller means for establishing functional relations between the contents of said respective tables to produce a sequence of micro-instructions and means providing at least one FIFO queue for storing those micro-instructions in order to constitute the final sequence of command instructions,

microprocessor means connected to said sequencing means to execute said command instructions and connected to said report production means using the aggregation results supplied by said microprocessor.

The present invention also provides an information medium that can be read by an electronic data processing system and where appropriate is fully or partially removable, in particular a CD-ROM, a magnetic medium such as a hard disk or a diskette, or a transmissible medium such as an electrical or optical signal, characterized in that it includes instructions of a computer program for executing the above method when that program is loaded into and executed by an electronic is data processing system.

The present invention also provides a computer program stored on an information medium, said program including instructions for executing the above method when that program is loaded into and executed by an electronic data processing system.

The invention will be better understood with the assistance of the following description, which is illustrated by the appended drawings, in which:

FIGS. 1 to 4 represent tables used to model data in the prior art.

FIG. 5 represents a table summarizing the main prior art data aggregation modes.

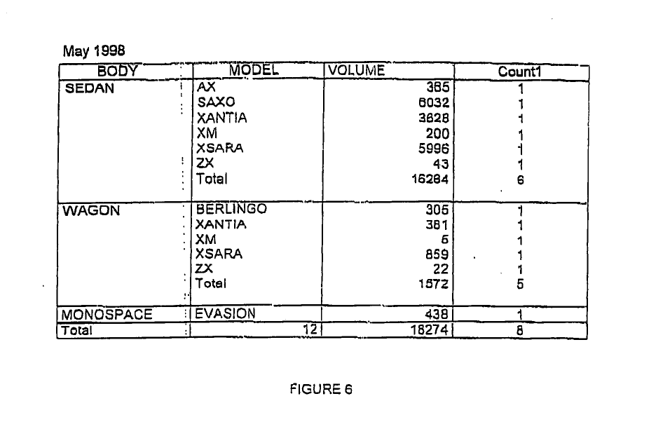

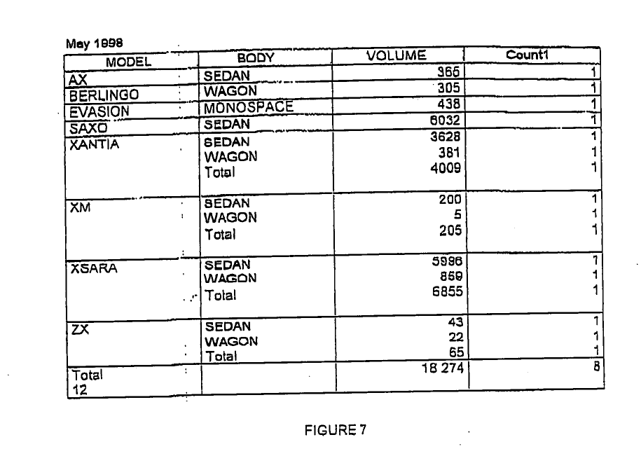

FIGS. 6 and 7 represent tables used to define a “hybrid” indicator of the invention.

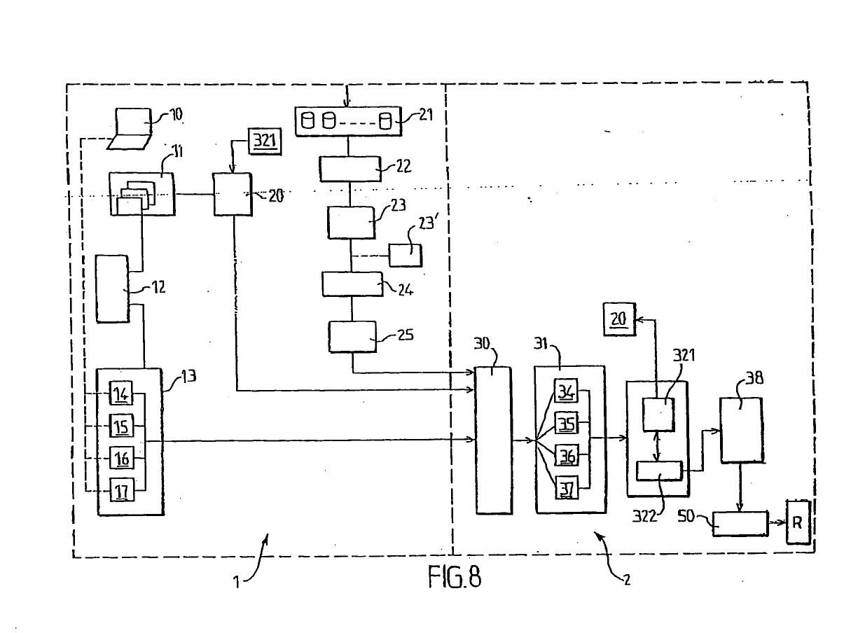

FIG. 8 is a functional diagram of the general architecture of the system of the invention.

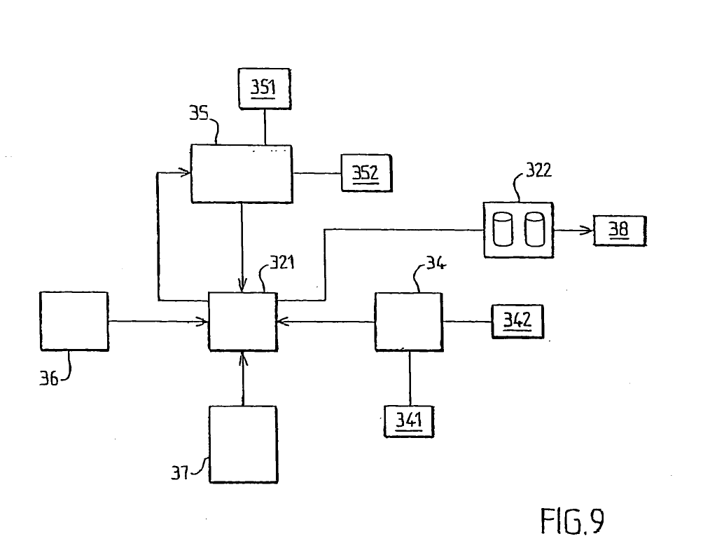

FIG. 9 is a functional diagram of the relations between sequencing means and buffer means of the invention.

### DESCRIPTION OF THE EMBODIMENT OF THE INVENTION

In this description, the expression “hybrid indicator” refers to an indicator allowing aggregation in two or more different aggregation modes corresponding to two or more different axes.

Consider, by way of example, the indicator Count1 in the FIG. 6 table defined as the number of Models (Model axis), independently of the Body (Body axis). Each time that a Model is found, the counter counts 1.

The aggregation mode for the indicator Count1 relative to the Body axis is the Constant mode. Consequently, at the time of global aggregation, the number of Models is recomputed without regard to the Body. As the Models XANTIA, XM, XSARA and ZX exist as a Sedan and as a Wagon, they are counted only once.

Accordingly, lumping all Bodies together, Count1 counts only eight models.

However, the Cumulable aggregation mode may be assigned to the indicator Count1 along the Model axis. Global aggregation along that axis will then lead to a total of 12.

If the construction of the data tree (data priority or tree) implies inverting the axes, the result of the aggregations remains exactly the same even if the presentation changes slightly (see FIG. 7).

The coexistence of the various types of modeling imposes a definition of the order of the various computations. The computations then always yield the same result, regardless of the position of the axes.

The order of the aggregation computations defined in accordance with the invention is as follows;

1. Nongroupable

2. Identical

3. Constant

4. Cumulable

5. Averageable (arithmetically or by weighting)

6. Compound Interest

7. Minimum

8. maximum.

In FIG. 8, which represents the general architecture of the system, the two modules 1 and 2 are outlined in dashed line.

The initialization module 1 combines all devices providing the various functions for initializing the automatic aggregation of metadata and raw data associated therewith necessary to drawing up a report.

Using a microcomputer 10, the operator employs selection means 20, for example pull-down menus, to select the type of report to be produced from a plurality of report types previously stored in first memory means 11, each type receiving a specific code and taking the form of a file containing the following information:

Name(s) or nature of the corresponding raw data, i.e. the data useful for drawing up this type of report,

Source of the corresponding raw data, i.e. the accessible Base(s) containing that raw data,

Access, i.e. the means of access to the above bases,

Name(s) of the metadata corresponding to said report type (Axes, Indicators, Aggregation functions), with no indication of the utilization parameters.

Second memory means 13 essentially comprise four main metadata files associated with their utilization parameters, namely:

an “Axes” file 14 supplying the codes and formatting attributes of all the axes that are operative in the types of preprogrammed report in the first memory means 11,

an “Indicators” file 15 supplying the names and formatting attributes of all the indicators useful for the types of preprogrammed report in the first memory means 11,

an “Aggregation functions” file 16 grouping the names of the aggregation functions, their mode of operation and a priority code relating to the application of those functions operative in all the types of preprogrammed report in the first memory means 11,

a “Metadata tree” file 17 specifies the trees to be used for each type of preprogrammed report in the first memory means 11.

All the above files and the prerecorded report types must enable periodic updating, which may be effected via direct links with the microcomputer 10 shown diagrammatically in dashed line.

Each item in these files 14, 15, 16 and 17 receives a particular code including the specific code cited above for the type of report to be drawn up only if said item must contribute to the generation of that type of report.

Coding means 12 carry out this coding conventionally.

The selection means 20 communicate with the first extraction means 23 to command the extraction of local or external raw data required to construct the type of report concerned and conveyed by any known means 22 for accessing said raw data, whether in the form of flat files, Excel files, relational databases (SQL, Access, Oracle, etc.) or resulting from external applications, or whether they as yet consist of intermediate results supplied by the microprocessor of the present processing system itself.

The extracted raw data may optionally be processed in additional processing means 23′ connected to the output of the extraction means 23 and essentially concerned with filtering and/or grouping data, each group formed thereafter may be considered a particular item.

The raw data, once extracted and (optionally) processed, is introduced into second coding means 24 for coding under the control of the selection means 20. The latter contain information bearing on the metadata relating to the selected report type and in particular to the names of the axis or axes and of the indicator(s) corresponding to that report type and that must be associated with said extracted raw data. Coding specifies which raw data is associated with which axis and which indicator.

After coding, said extracted and (optionally) processed raw data is stored ready for use in storage means 25.

The execution module 2 generates and executes command instructions, essentially computation instructions. Second extraction means 30, under the control of the selection means 20, take from the files 14, 15, 16 and 17 the metadata relating to the report type selected in the selection means 20. In parallel with this, the second extraction means 30 take from the storage means 25 the data previously coded by the coding means 24 to be associated correctly with the metadata extracted by the same extraction means 30. Buffer means 31 comprise respective tables 34, 35, 36 and 37 that receive the metadata and the associated raw data extracted by said second extraction means 30.

As soon as the type of report has been selected, the tables 34, 35, 36, 37 should contain the metadata relating to that report type and the corresponding utilization parameters thereof, as well as the raw data associated with that metadata. The utilization parameters and the raw data both associated with said metadata may be in separate files that nevertheless have links with the basic table 34, 35, 36 or 37.

For example, the Axes table 34 contains directly the name of the axis, its code and its formatting attributes, and may, on the other hand, communicate with separate auxiliary files 341, 342 (represented in FIG. 2) in respect of the list of the items on that axis supplied by the associated raw data or the properties of the axis that describe manipulations (grouping of items, changes of name, etc.) effected on each axis and as a function of the data of that axis.

The Indicators table 35 representing an extract from the file 15 that corresponds to a given report type concerns the indicator(s) required to process the selected report type and indicates their name(s) and their formatting attribute(s), as well as their numerical values (associated raw data) corresponding to each item of each axis required.

To take account of the hybrid indicators, the aggregation function and the axis to which it relates are integrated as utilization parameters stored as above in auxiliary files 351, 352 (represented in FIG. 2) accessible from the table 35 and identified by appropriate coding means. Accordingly, implementing the electronic data processing architecture described enables automatic processing of hybrid indicators and this avoids interrupting the process of drawing up the report on each change of aggregation axis.

The table 36 of aggregation functions contains the function(s) always required to generate the same selected report type and their mode of application, bearing on one or more indicators that are also required and on the various aggregation axes concerned. Another parameter is operative in the use of the aggregation functions, and concerns the priority of the aggregation computations, as defined at the beginning of this description, to maintain the independence of the results corresponding to a hybrid indicator of the position of the axes in the data tree.

The required trees are stored in the trees table 37, which is constructed from trees programmed in the file 17 of the first memory means 13. The table 37 supplies information for organizing the computations according, firstly, to the designation of the aggregation and computation axes and, secondly, to the required aggregation functions.

The sequencing means 32 contain a microcontroller 321 essentially connected to the respective tables 34, 35, 36 and 37 to set up, using the method described below, the final sequence of command instructions that will be executed at each node of this sequence by microprocessor means 38 whereof the arithmetic and logic unit and the control unit are microprogrammed to execute the aggregation calculations integrated into said command instructions.

The operation of the microcontroller 321 is described next with reference to FIG. 9.

The microcontroller receives from the table 37 the first tree required, which enables the microcontroller to take the required axis from the axes table 34, the code whereof confirms that it is an aggregation axis and the properties whereof and the associated items are accessible from auxiliary files 341 and 342 by recognition of the axis code.

Knowing the first axis, the microcontroller accesses the first indicator required in the indicators table 35 and its utilization parameters stored in the auxiliary filed 351 and 352.

Using the above information, the microcontroller 321 defines the aggregation function that it has to extract from the functions table 36 with its application parameters.

The microcontroller 321 can then establish the micro-instructions relating to the first aggregation computation on the successive items on the axis concerned, those micro-instructions being stored in an FIFO (first in first out) queue 322. The number of bits in the micro-instructions defines the number of FIFO queues required.

For example, assuming the Cumulable indicator, the micro-instructions may be translated as follows:

take the numerical value 1 of the required indicator corresponding to the item 1 on the required axis, add thereto the numerical value 2 of the required indicator corresponding to the item 2 on the required axis, add thereto the numerical value 3, etc. Once the operation has been completed for all of the items on the axis and their corresponding indicator values, the process starts over with the next indicator or the next axis required and the items relating to that axis.

All the micro-instructions that constitute the final command instruction to be executed by the microprocessor 38 are recovered at the exit of the queue(s) 322.

The microcontroller is programmed, as soon as the operation executed by the microprocessor 38 has been completed, i.e. as soon as all the items resulting from the aggregation of the data necessary to establish the selected report type have been obtained and supplied to the means for producing the report, to activate the first selection means 20 in order to select automatically a new type of report and simultaneously to reinitialize the storage means 25, the buffer means 31 and the queue means 322.

A minimum configuration for the microprocessor 38 depends on the volume of data processed and, for a conventional management information system report, a 400 MHz Intel Pentium II microprocessor produces virtually instantaneous response times, for example.

The results are transmitted from the microprocessor 38 to the production means 50, which group together:

design of the presentation or tables, diagrams and text in the report,

circulation strategy, which Includes selecting the medium on which to circulate the report (electronic mail, postal service, intranet, etc.), the output file format, the circulation target (personalized or more generalized).

Moreover, some or all of the results may be fed back into the circuit from the microprocessor 38 and integrated into an additional database for raw data in the database means 21, thus saving time by avoiding starting over operations that are common to more than one type of report.

1-15. (canceled)

16. Device for processing metadata and associated raw data adapted to aggregate the latter with a view to drawing up a plurality of types or report, characterized in that the device is rendered automatic by the use of the combination of the following two modules constituting the device:
an initialization module (1) including:
microcomputer means (10),
automatically accessible first memory means (11) for storing characteristics of said plurality of report types,
second memory means (13) organized into files (14, 15, 16, 17) for storing metadata of the type analysis axis, indicator, aggregation function and metadata tree, relating to each report type of said plurality of report types and with which utilization parameters are associated, taking into account at least one hybrid indicator adapted to allow aggregation in at least two different aggregation modes corresponding to at least two different analysis axes,
first coding means (12) connected between the first memory means (11) and the second memory means (12) to code each item of metadata and each of its associated utilization parameters as a function of the preprogrammed report type to which they relate,
selection means (20) connected between the first memory means (11) to select at least one given report type from said preprogrammed plurality of report types,
local or external raw data database means (20) that can be associated with said metadata and are provided with access means (22),
first extraction means (23) for extracting said associated raw data connected to said access means (22) and to said selection means (20) to extract the raw data associated with said metadata relating to at least one selected report type,
second coding means (24) for coding said raw data extracted by said first extraction means (23) to assure a correct association between it and the metadata relating to said report type selected by selection means (20),
storage means (25) connected to said second coding means (24) for storing said extracted raw data,
an execution module (2) for producing command instructions and including:
second extraction means (30) connected to said second memory means (13), said selection means (20) and said storage means (25) of the initialization module (1),
buffer means (31) coupled to said second extraction means (30) to store, firstly, the metadata, taken from the files (14, 15, 16, 17), relating to at least one given report type selected by said selection means (20) in the respective tables (34, 35, 36, 37) and, secondly, for completing said respective tables (34, 35, 36, 37) with said associated raw data extracted from said storage means (25) by said second extraction means (30), said respective tables (34, 35, 36, 37) therefore containing the metadata relating to the selected report type, their corresponding utilization parameters and the raw data associated with said metadata,
sequencing means (32) coupled to the buffer means (31) and comprising microcontroller means (321) for establishing functional relations between the contents of said respective tables (34,35, 36, 37) relating to the metadata tree, axis, indicator and aggregation function to produce a sequence of micro-instructions in corresponding relationship to the various aggregation modes with respect to at least two different axes of at least one hybrid indicator and means providing at least one FIFO queue (322) for storing those micro-instructions in order to constitute the final sequence of command instructions, and
micropocessor means (38) connected to said sequencing means (32) to execute said command instructions and connected to said report production means (50) using the results of the various aggregation modes with respect to at least two different axes of at least one hybrid indicator supplied by said microprocessor (38).

17. Method of processing metadata and associated raw data adapted to aggregate the latter with a view to drawing up a plurality of types of report, characterized in that it comprises the following steps:
a) initializing first memory means (11) and second memory means (12) of an initialization module (1) and introducing thereinto, in files (14, 15,16, 17), the respective characteristics of the preprogrammed types of report (11) and the respective parameters associated with the metadata of the type analysis axis, indicator, aggregation function and metadata tree,
b) establishing correspondence links between the report types and the metadata,
c) selecting one of the types of report to be drawn up,
d) as a function of the selected report type and using first extraction means, (23), extracting local or external raw data,
e) coding said extracted raw data as a function of metadata relating to at least one selected report type,
f) storing said raw data coded in this way,
g) extracting from the files (14, 15,16, 17) the metadata and the utilization parameters thereof relating to at least one selected report type, taking into account at least one hybrid indicator adapted to allow aggregation in at least two different aggregation modes corresponding to at least two different analysis axes and being identified by their respective codes,
h) transferring said extracted metadata into respective tables (34, 35, 36, 37),
i) also transferring into said tables(34,35,36,37) said stored coded raw data to complete said respective tables, said respective tables therefore containing the metadata relating to the selected report type, their corresponding utilization parameters and the raw data associated with said metadata,
j) establishing a sequence of command micro-instructions under the control of a microcontroller (321) as a function of the functional relationships between contents relating to the trees, axis, indicator and aggregation function of said respective tables and in corresponding relationship to the various aggregation modes with respect to at least two different axes of at least one hybrid indicator,
k) storing all said micro-instructions in at least one FIFO queue (322) in preparation for a final sequence of command instructions addressed to said microprocessor (38),
l) executing said sequence of command instructions with the aid of the microprocessor means (38), the results of which take account of the various aggregation modes with respect to at least two different axes of at least one hybrid indicator and are either transmitted to the functional units adapted to fabricate at least one selected type of report (R) or returned to the database means (21) for raw data in order to constitute a new database reusable to draw up another type of report.

18. Information medium that can be read by an electronic data processing system and where appropriate is fully or partially removable, in particular a CD-ROM, a magnetic medium such as a hard disk or a diskette, or a transmissible medium such as an electrical or optical signal, characterized in that it includes instructions of a computer program for executing a method according to claim 17 when that program is loaded into and executed by an electronic data processing system.

19. Computer program stored on an information medium, said program including instructions for executing a method according to claim 17 when that program is loaded into and executed by an electronic data processing system.
